(19) United States
(12) Patent Application Publication
(10) Pub. No.: US 2004/0071052 A1
(43) Pub. Date: Apr. 15, 2004

(54) Optical pickup apparatus and adjustment method therefor

(75) Inventors: Toru Hanaoka, Higashihiroshima-Shi (JP); Masahiro Nakamura, Higashihiroshima-shi (JP); Nobumasa Ono, Higashihiroshima-Shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka (JP)

(21) Appl. No.: 10/665,877

(22) Filed: Sep. 19, 2003

(30) Foreign Application Priority Data
Sep. 20, 2002 (JP) 2002-275900
Jun. 9, 2003 (JP) 2003-163840

(51) Int. Cl. G11B 7/095

(52) U.S. Cl. 369/44.14

(57) ABSTRACT

An object of the invention is to provide an optical pickup apparatus that succeeded in achieving easy wiring layout and slenderization, and an easy adjustment method therefor. In the optical pickup apparatus, the position of the working light with respect to the recording medium is adjusted by positionally adjusting at least one of the optical components. Particularly by forming the opening portion in an area of the first wiring board which is located in proximity to the optical component, the wiring region of the first wiring board can be secured without covering the optical component completely.

### BACKGROUND OF THE INVENTION

1. Field of the Invention

The present invention relates to an optical pickup apparatus for reading information recorded on an optical disk medium and recording information on an optical disk medium.

2. Description of the Related Art

FIG. 11 is a perspective view schematically showing an optical pickup apparatus 1 according to a first prior art. FIG. 12 is an exploded perspective view showing the principal portion of the optical pickup apparatus 1 of the first prior art. FIG. 13 is a sectional view of the optical pickup apparatus 1 of the first prior art, illustrating a positional relationship between a rotatable semiconductor laser 2 and a wiring board 3 with a pressing member 4. Conventionally, as shown in FIGS. 11 to 13, in the optical pickup apparatus 1, using the semiconductor laser 2 composed of a light-emitting element which is integrally formed with a diffraction grating 5, optical adjustment is conducted during its assembly by rotating the light-emitting element 2.

Inside a metal-made housing 6 are arranged the semiconductor laser 2 integrally formed with the diffraction grating 5; a light-receiving element 7; a collimate lens 8; a beam splitter 9; a raising mirror 10; and an actuator 12 having an objective lens 11 mounted thereon. Fixedly attached to one thicknesswise end portion of the optical pickup main body is one lengthwise end portion of the wiring board 3 (hereafter also referred to as a “flexible printed circuit board” 3) for covering most of the above-mentioned mount components.

Fixedly attached to part of the surface of one end of the flexible printed circuit board 3 is the metal-made pressing member 4 for preventing the flexible printed circuit board 3 from upwardly moving out of the optical pickup main body. The flexible printed circuit board 3 has its other end portion arranged in the other thicknesswise end portion of the optical pickup main body. A connecter portion 3a, which is attached to the other end portion of the flexible printed circuit board 3, is connected relatively to a drive or a player. The flexible printed circuit board 3 has its lengthwise substantially middle portion kept curved.

The light emitted from the semiconductor laser 2 passes through the collimate lens 8, the beam splitter 9, and the raising mirror 10 in this order, and is then focused onto a recording surface of an optical disk 13 by the objective lens 11. By arranging the diffraction grating 5 partway along the optical path, a ray of light is split into three light beams. Thereby, three focal points proximate to one another are created on the optical disk 13. In the recording layer of the optical disk 13, digital data is recorded by means of a recording mark. The recording mark is so configured that the digital data is detectable according to a difference in reflectance.

On one surface of the optical disk 13 are arranged three light spots in an array. The interval between the adjacent spots is adjusted in advance to be a value equal to ½ of the track pitch (the interval between the adjacent recording mark arrays in the optical disk 13). Therefore, when, of the three spots arranged at predetermined intervals, the central spot is superimposed on the signal array, the other two spots at the extremity are each deviated by ½ pitch from the signal array.

The light reflected from the recording surface of the optical disk 13 passes through the objective lens 11, the raising mirror 10, and the beam splitter 9 in this order, and then enters the light-receiving element 7. Then, computation is performed on the signals of the three spots, and a feedback signal is fed to the actuator 12 so as to maintain the current status. Eventually, the objective lens 11 changes its position. Thereby, the spots are allowed to follow the recording signal array of the optical disk 13 rotating at high speed. Hence, by detecting variation in the quantity of the light that entered the light-receiving element 7 after being reflected from the recording surface, the information recorded on the optical disk 13 can be read out. In the optical pickup apparatus 1, to ensure that the interval among the three split light beams conforms to the track pitch, for example, the semiconductor laser 2 integrally formed with the diffraction grating 5 needs to be adjusted by rotation during the assembly of the optical pickup apparatus 1.

FIG. 14 is a perspective view schematically showing an optical pickup apparatus 14 according to a second prior art. FIG. 15 is a sectional view of the optical pickup apparatus 14 of the second prior art, illustrating a positional relationship between a rotatable semiconductor laser 2A, a flexible printed circuit board 15 and a pressing member 16. In the optical pickup apparatus 14, the flexible printed circuit board 15 and the pressing member 16 have opening portions 15a and 16a, respectively, formed in the entire area thereof facing toward the semiconductor laser 2A. In this case, even if the flexible printed circuit board 15 and the pressing member 16 are moved closer to the semiconductor laser 2A as shown in FIG. 13, the semiconductor laser 2A can be rotationally adjusted without making contact with the flexible printed circuit board 15 and the pressing member 16.

In addition, there is disclosed a technique for preventing a printed circuit board from slipping out of a pickup main body, during rotational adjustment to a semiconductor laser, by taper-shaping the outer edge of the printed circuit board (for example, Japanese Unexamined Patent Publication JP-A6-243477 (1994, refer to Page 3 and FIG. 2)).

In recent years, with the development of compact and slim portable optical disk drives and optical disk players, there has been an increasing demand for slimness and compactness in an optical pickup apparatus which is incorporated in an optical disk drive. To achieve slenderization of an optical pickup apparatus, an interval between a semiconductor laser with a light-receiving element and a flexible printed circuit board with a pressing member needs to be made as narrow as possible.

In the optical pickup apparatus 1 of the first prior art, the interval between the semiconductor laser 2 and the flexible printed circuit board 3 is determined in consideration of the dimensional deviation of the semiconductor laser 2 per se and variation in the mounting position. In addition to that, it is necessary to ensure that the semiconductor laser 2 is kept out of contact with the flexible printed circuit board 3 even when the rotation angle of the semiconductor laser 2 is maximized, as indicated by the dash-and-dot line and the dash-dot-dot line in FIG. 13, at the time of the rotational adjustment to the semiconductor laser 2 as explained above. Hence, as shown in FIG. 13, an interval 5 needs to be additionally secured between the semiconductor laser 2 and the flexible printed circuit board 3. This makes slenderization of the optical pickup apparatus impossible.

In the optical pickup apparatus 14 of the second prior art, even if the flexible printed circuit board 15 and the pressing member 16 are moved closer to the semiconductor laser 2A as shown in FIG. 15, the semiconductor laser 2A can be rotationally adjusted without making contact with the flexible printed circuit board 15. In this construction, however, the flexible printed circuit board 15 has the opening portion 15a formed in the entire area thereof facing toward the semiconductor laser 2A. This makes it difficult to carry out wiring for the electronic components to be mounted on the flexible printed circuit board 15.

Moreover, in the optical pickup apparatus 1 of the first prior art, to achieve proper rotational adjustment to the semiconductor laser 2, the semiconductor laser 2 needs to be rotated, in a light-emitting state, with its upper and lower side faces retained with use of an adjustment tool. However, in the optical pickup apparatus 1 having the above-described structure, since the semiconductor laser 2A has its upper side face covered with the flexible printed circuit board 3, the adjustment tool cannot be applied thereto. To insert the adjustment tool, as shown in FIG. 16, one lengthwise end portion of the flexible printed circuit board 3 needs to be lifted so as for the upper and lower side faces 2b of the semiconductor laser 2 to be temporarily exposed. This makes the operation process complicated, and also gives rise to a risk that the flexible printed circuit board 3 suffers from damage resulting from an excessively strong pull or abutment with the tool, when lifted.

Furthermore, after being adjusted to have the desired rotation angle by means of the adjustment tool, the semiconductor laser 2 needs to be fixed by bonding to the housing with use of ultraviolet curing resin or the like material. To achieve this, in the optical pickup apparatus 14 having the above-described structure, as shown in FIG. 16, one lengthwise end portion of the flexible printed circuit board 3 is lifted, and the ultraviolet curing resin is applied to a resultant exposed gap 2c between the semiconductor laser 2 and the housing 6. Also in this case, the operation process becomes complicated, and further, particularly in a case where the gap is too narrow to be discerned visually, there is a possibility of occurrence of an error in the application position of the resin material or insufficiency of the application amount thereof.

### SUMMARY OF THE INVENTION

Accordingly, an object of the invention is to provide an optical pickup apparatus that succeeded in achieving easy wiring layout and slenderization, and an easy adjustment method for the optical pickup apparatus.

The invention provides an optical pickup apparatus comprising:

a plurality of optical components including a light-emitting element which emits working light for recording or reproducing information with respect to a recording medium;

a housing for mounting therein the optical components; and

a first wiring board which is electrically connected to the light-emitting element,

wherein at least one of the optical components is made positionally adjustable,

and wherein the first wiring board has an opening portion formed in an area thereof which is located in proximity to the positionally-adjustable optical component.

According to the invention, in the optical pickup apparatus in which the position of the working light with respect to the recording medium is adjusted by positionally adjusting at least one of the optical components, it is possible to secure a wiring region in the first wiring board in proximity to the optical component. Particularly, by forming the opening portion in that area of the first wiring board which is located in proximity to the optical component, the wiring region of the first wiring board can be secured without covering the optical component completely.

In the invention, it is preferable that, in the first wiring board, an opening portion is formed in an area facing toward part of the positionally-adjustable optical component that undergoes significant displacement at the time of positional adjustment to the optical component.

According to the invention, the opening portion is formed only in that area of the first wiring board which faces toward part of the optical component that undergoes significant displacement at the time of positional adjustment to the optical component. Hence, at the time of positionally adjusting the optical component, the part subjected to significant displacement passes through the opening portion. This helps prevent the optical component from abutting against the first wiring board. Moreover, it is possible in particular to secure the wiring region of the first wiring board. In other words, the wiring region can be secured in that area of the first wiring board which is free of the opening portion facing toward the part subjected to significant displacement. In this way, by forming the opening portion only in that area of the first wiring board which faces toward the part subjected to significant displacement, it is possible to easily realize the optical pickup apparatus that can have the wiring region secured in the first wiring board and that can nevertheless be made slimmer.

In the invention, it is preferable that a gap is created between the positionally-adjustable optical component and the housing arranged adjacent to the optical component, and that the first wiring board has an opening portion formed in an area thereof which faces toward the gap.

According to the invention, that part of the positionally-adjustable optical component which is adjacent to the housing is exposed without being covered with the first wiring board. Thus, after the positional adjustment, a fluid material such as ultraviolet curing resin can be applied, or ultraviolet rays can be irradiated, through the opening portion, to the gap between the positionally-adjustable optical component and the housing.

In the invention, it is preferable that a pressing member is additionally provided to prevent the first wiring board from being displaced in a direction such as to move away from the optical component.

According to the invention, by the action of the pressing member, the first wiring board can be prevented without fail from being inconveniently displaced in a direction such as to move away from the optical component.

In the invention, it is preferable that the first wiring board is formed as a flexible wiring board. According to the invention, since the first wiring board is formed as a flexible wiring board, by exploiting its flexibility, the layout and displacement of the first wiring board can be achieved with ease. By employing the first wiring board having flexibility, the optical pickup apparatus can be driven with moveability. Moreover, even though the part of the optical component subjected to significant displacement is brought into abutment with the periphery of the opening portion, since the first wiring board possesses flexibility, the periphery of the opening portion is elastically deformed at that time. Therefore, the force transmitted from the optical component to the first wiring board can be dispersed. As a result, the optical component can be prevented from being positionally deviated after the positional adjustment, and also further slenderization of the optical pickup apparatus can be achieved.

In the invention, it is preferable that the positionally-adjustable optical component includes a light-emitting element which has a diffraction grating integrally formed therewith for making working light beams converge at a plurality of positions on a recording medium.

According to the invention, the light-emitting element has the diffraction grating integrally formed therewith for making working light beams converge at a plurality of positions on a recording medium. Thus, by positionally adjusting the light-emitting element, the diffraction grating integrally formed with the light-emitting element is positionally adjusted. Performing positional adjustment on the diffraction grating makes it possible to adjust the pitch among a plurality of positions of the working light beams converging on the recording medium.

In the invention, it is preferable that a rotatable holder is additionally provided for accommodating the optical component, and that the optical component can be positionally adjusted by rotation of the holder.

According to the invention, by rotating the holder, the optical component is positionally adjusted. That is, the positional adjustment can be achieved simply by rotating the holder. Thus, even if the optical component is too small to be gripped, since there is no need to have a direct grip on the optical component, adjustment can be achieved with ease.

In the invention, it is preferable that a second wiring board is additionally provided that is electrically connected to the first wiring board, is made rotatable, and has the optical component mounted thereon, and that the optical component can be positionally adjusted by rotation of the second wiring board.

According to the invention, the optical component is mounted on the second wiring board, and, by rotating the second wiring board electrically connected to the first wiring board, the optical component can be positionally adjusted.

In the invention, it is preferable that the positionally-adjustable optical component includes a light-receiving element.

According to the invention, the light-receiving element can be positionally adjusted. At the time of positionally adjusting the light-receiving element, the light-receiving element and the first wiring board can be prevented from making contact with each other. Moreover, it is possible to secure the wiring region of the first wiring board.

In the invention, it is preferable that the positionally-adjustable optical component is a light emitting/receiving element constituted by combining together a light-emitting element and a light-receiving element.

According to the invention, positional adjustment can be performed on the light emitting/receiving element composed of a combination of a light-emitting element and a light-receiving element. At the time of positionally adjusting the light emitting/receiving element, the light emitting/receiving element and the first wiring board can be prevented from making contact with each other. Moreover, it is possible to secure the wiring region of the first wiring board.

In the invention, it is preferable that the opening portion of the flexible wiring board is slit-shaped.

According to the invention, since the opening portion of the flexible wiring board is slit-shaped, at the time of positionally adjusting the optical component, the part of the optical component subjected to significant displacement passes through the slit-shaped opening portion. This helps prevent the to-be-adjusted optical component from abutting against the flexible wiring board. Even though the part of the optical component subjected to significant displacement is brought into abutment with the periphery of the slit-shaped opening portion, the optical component can be prevented from being positionally deviated after the positional adjustment.

In the invention, it is preferable that the opening portion is formed as a notch extending over an outer edge of the first wiring board.

According to the invention, at the time of positionally adjusting the optical component, the part of the optical component subjected to significant displacement passes through the notch-shaped opening portion extending over the outer edge of the first wiring board. This helps prevent the to-be-adjusted optical component from abutting against the first wiring board. Even though the part of the optical component subjected to significant displacement is brought into abutment with the periphery of the notch-shaped opening portion, the optical component can be prevented from being positionally deviated after the positional adjustment.

The invention provides a method for adjusting an optical pickup apparatus composed of a plurality of optical components including a light-emitting element which emits working light for recording or reproducing information with respect to a recording medium; a housing for mounting therein the optical components; and a first wiring board which is electrically connected to the light-emitting element, comprising the steps of:

making at least one of the optical components positionally adjustable;

forming an opening portion in an area of the first wiring board which faces toward part of the optical component that undergoes significant displacement at the time of positional adjustment; and

adjusting the position of the positionally-adjustable optical component by means of an adjustment tool inserted externally through the opening portion.

According to the invention, the positionally-adjustable optical component is subjected to positional adjustment operations such as rotation, while being gripped by the adjustment tool inserted through the opening portion. That is, the position of the positionally-adjustable optical component can be adjusted without moving the first wiring board which is electrically connected to the light-emitting element and covers the positionally-adjustable optical component. This helps facilitate the assembly and adjustment of the pickup apparatus.

The invention further provides a method for adjusting an optical pickup apparatus composed of a plurality of optical components including a light-emitting element which emits working light for recording or reproducing information with respect to a recording medium; a housing for mounting therein the optical components; and a first wiring board which is electrically connected to the light-emitting element, comprising the steps of:

making at least one of the optical components positionally adjustable;

forming an opening portion in an area of the first wiring board which faces toward a gap created between the positionally-adjustable optical component and the housing arranged adjacent to the optical component; and

bonding the positionally-adjustable optical component to the housing by applying an adhesive through the opening portion.

According to the invention, the positionally-adjustable optical component can be bonded to the housing without moving the first wiring board which is electrically connected to the light-emitting element and covers the positionally-adjustable optical component. This helps facilitate the assembly and adjustment of the pickup apparatus.

The invention still further provides a method for adjusting an optical pickup apparatus composed of a plurality of optical components including a light-emitting element which emits working light for recording or reproducing information with respect to a recording medium; a housing for mounting therein the optical components; and a first wiring board which is electrically connected to the light-emitting element, comprising the steps of:

making at least one of the optical components positionally adjustable;

forming an opening portion in an area of the first wiring board which faces toward a gap created between the positionally-adjustable optical component and the housing arranged adjacent to the optical component;

adjusting the position of the positionally-adjustable optical component by means of an adjustment tool inserted externally through the opening portion; and

bonding the positionally-adjustable optical component to the housing by applying an adhesive through the opening portion.

According to the invention, after the position of the positionally-adjustable optical component is adjusted by means of the adjustment tool inserted externally through the opening portion, the positionally-adjustable optical component is bonded to the housing by applying an adhesive through the opening portion. This helps facilitate the assembly and adjustment of the pickup apparatus.

### BRIEF DESCRIPTION OF THE DRAWINGS

Other and further objects, features, and advantages of the invention will be more explicit from the following detailed description taken with reference to the drawings wherein:

FIG. 1 is a perspective view schematically showing an optical pickup apparatus according to an embodiment of the invention;

FIG. 2 is an exploded perspective view showing the principal portion of the optical pickup apparatus;

FIG. 3 is a sectional view showing the positional relationship between a rotatable semiconductor laser and a first wiring board and a pressing member;

FIG. 4 is a front view showing the positional relationship among three light spots irradiated from the optical pickup apparatus onto a recording medium, as viewed in one direction of the thickness of the recording medium;

FIG. 5 is a perspective view of a modified embodiment obtained by partly modifying the embodiment of the invention, illustrating an optical pickup apparatus in which the opening portion of the first wiring board is slit-shaped;

FIG. 6 is a perspective view of a modified embodiment obtained by partly modifying the embodiment of the invention, illustrating an optical pickup apparatus in which the opening portion of the first wiring board is notch-shaped;

FIG. 7 is an exploded perspective view of another embodiment of the invention, illustrating an optical pickup apparatus provided additionally with a second wiring board which is electrically connected to a first wiring board, is made rotatable, and has an optical component mounted thereon;

FIGS. 8A through 8C are partly enlarged views of the second wiring board and the semiconductor laser, with FIG. 8A showing a perspective view of the second wiring board and the semiconductor laser, FIG. 8B showing a front view of the second wiring board as seen from one side in x direction, and FIG. 8C showing a sectional view of the second wiring board and the semiconductor laser sectioned along a virtual plane which is perpendicular to y direction;

FIG. 9 is a sectional view of a fourth embodiment obtained by partly modifying the embodiment of the invention, illustrating the positional relationship among the semiconductor laser, the flexible printed circuit board, and an adjustment tool;

FIG. 10 is a view showing the front and side of the adjustment tool;

FIG. 11 is a perspective view schematically showing an optical pickup apparatus according to a first prior art;

FIG. 12 is an exploded perspective view showing the principal portion of the optical pickup apparatus of the first prior art;

FIG. 13 is a sectional view of the optical pickup apparatus of the first prior art, illustrating the positional relationship between a rotatable semiconductor laser and a wiring board and a pressing member;

FIG. 14 is a perspective view schematically showing an optical pickup apparatus according to a second prior art;

FIG. 15 is a sectional view of the optical pickup apparatus of the second prior art, illustrating the positional relationship between a rotatable semiconductor laser and a flexible printed circuit board with a pressing member; and

FIG. 16 is a schematic view of the optical pickup apparatus of the first prior art, for explaining the necessity of lifting the flexible printed circuit board at the time of positional adjustment to the semiconductor laser.

### DETAILED DESCRIPTION OF THE PREFERRED EMBODIMENTS

Now referring to the drawings, preferred embodiments of the invention are described below.

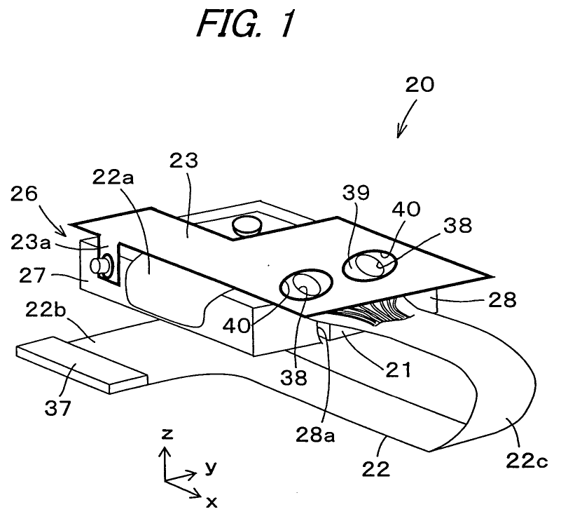

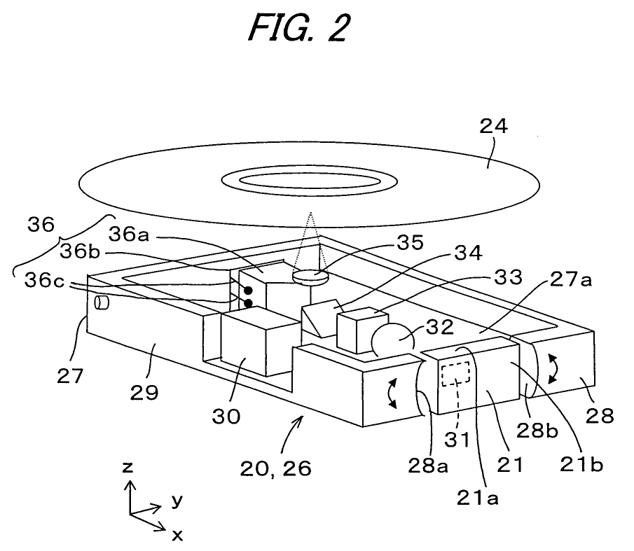

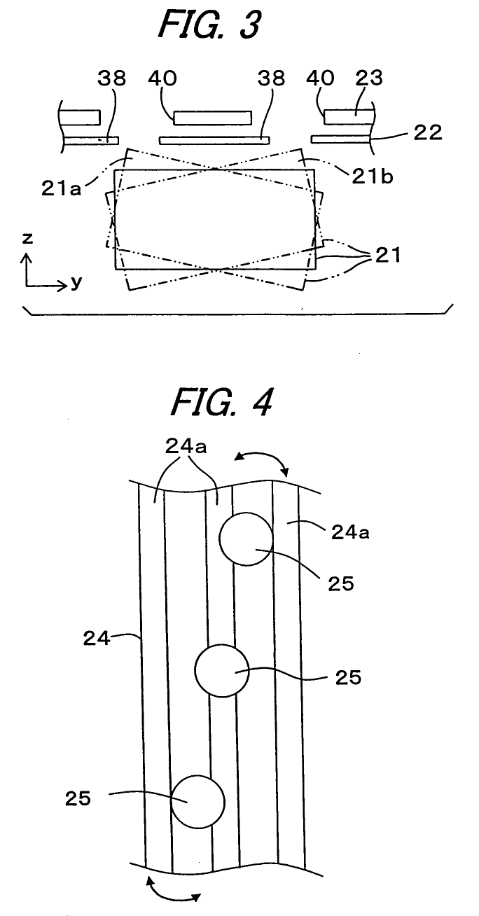

FIG. 1 is a perspective view schematically showing an optical pickup apparatus 20 according to an embodiment of the invention. FIG. 2 is an exploded perspective view showing the principal portion of the optical pickup apparatus 20. FIG. 3 is a sectional view showing the positional relationship between a rotatable semiconductor laser 21, a first wiring board 22 and a pressing member 23. FIG. 4 is a front view showing the positional relationship among three light spots 25 irradiated from the optical pickup apparatus 20 onto a recording medium 24, as viewed in one direction of the thickness of the recording medium 24. The optical pickup apparatus 20 according to the embodiment is incorporated in for example an optical disk drive.

The optical pickup apparatus 20 is mainly composed of an optical pickup main body 26; the first wiring board 22 which is electrically connected to the semiconductor laser 21 of the optical pickup main body 26; and the pressing member 23 which will be described later. The optical pickup main body 26 is composed of a housing 27 and a plurality of optical components which are mounted in the housing 27. The housing 27 is shaped into a rectangular casing with its one side opened. The bottom portion 27a of the housing 27 is substantially rectangular in shape when viewed in the thicknesswise direction. Note that the term “substantially rectangular shape” is to be interpreted as including a rectangular shape. In the optical pickup main body, in the vicinity of the lengthwise middle position of one side wall portion 28 (i.e. the rectangular shorter side) of the housing 27 is formed by incision the semiconductor laser 21, acting as a light-emitting element, so as to be positionally adjustable. That is, in the vicinity of the lengthwise middle position of the one side wall portion 28 is arranged the subsequently-described semiconductor laser 21 so as to be positionally adjustable. The one side wall portion 28 includes a pair of wall portions 28a and 28b facing toward the semiconductor laser 21. The wall portions 28a and 28b are each spaced a predetermined distance away from the semiconductor laser 21, and concavely curved with respect to the semiconductor laser 21.

A longer side wall portion 29 is perpendicularly adjacent to the one side wall portion 28 of the housing 27. In the vicinity of the lengthwise middle position of the longer side wall portion 29 is formed by incision a light-receiving element 30, which will be described later, so as to be positionally adjustable. That is, in the vicinity of the lengthwise middle position of the longer side wall portion 29 is arranged the subsequently-described light-receiving element 30 so as to be positionally adjustable. Hereafter, the direction of the optical axis for the light emitted from the semiconductor laser 21 is defined as x direction, the direction which is perpendicular to the x direction within the bottom surface of the housing is defined as y direction, and the direction which is perpendicular to the x and y directions is defined as z direction.

A plurality of optical components mounted in the housing 27 includes: the semiconductor laser 21; the light-receiving element 30; a diffraction grating 31; a collimate lens 32; a beam splitter 33; a raising mirror 34; an objective lens 35; and an actuator 36. The semiconductor laser 21 is rectangular-shaped and has, on its one surface facing inside of the housing 27, the diffraction grating 31 formed integrally therewith for splitting the working light emitted from the semiconductor laser 21 into three light beams. The diffraction grating 31 also serves to make the three working light beams converge at different positions on an optical disk 24 which will be described later. On the bottom portion 27a of the housing 27 are arranged, from the semiconductor laser 21 side, the collimate lens 32, the beam splitter 33, the raising mirror 34, and the actuator 36 in this order along one direction in which the semiconductor laser 21 emits light.

The actuator 36 includes: an actuator main body 36a having a plurality of coils and magnets arranged therewithin so as to be oriented differently with respect to each other; a wire 36b for providing electrical connection between the coil and the first wiring board 22; and an actuator wiring board 36c. The magnet disposed within the actuator main body 36a is so arranged as to be movable along the y and z directions by generating a magnetic field through application of a current to the coil, and the objective lens 35 is fixed to one end of the magnet. That is, the objective lens 35 is allowed to move along the y and z directions by the actuator 36. On one z direction-wise side of the optical pickup main body 26 facing toward the objective lens 35 is disposed (arranged) the optical disk 24 acting as a recording medium.

In the optical disk drive is disposed the optical disk 24 so as to be rotatable about the axis in the z direction. In the recording layer of the optical disk 24 is recorded digital data by means of a recording mark. The recording mark is so configured that the digital data, for example sound-accompanying image data or text data, is detectable according to a difference in reflectance. The three working light beams (hereafter also referred to simply as “light”) that have been emitted from the semiconductor laser 21 and directed via the diffraction grating 31, along the x direction, toward the collimate lens 32, are then converted into parallel light beams by the collimate lens 32. The parallel light beams thus converted are directed via the beam splitter 33 toward the raising mirror 34, and are then reflected from the raising mirror 34 in the z direction. The parallel light beams thus reflected converge on part of the surface of the optical disk 24, as three light spots 25 arranged in an array, through the objective lens 35.

The three light spots 25 are arranged in an array on part of the surface of the optical disk 24. The interval between the adjacent light spots 25 is adjusted in advance to be a value equal to ½ of the track pitch (the interval between the adjacent recording mark arrays 24a in the optical disk 24). Therefore, when, of the three light spots 25 arranged at predetermined intervals, the central light spot 25 is superimposed on the recording mark array 24a, the other two light spots 25 at the extremity are each deviated by ½ of the track pitch from the recording mark array 24a.

The light-receiving element 30 is capable of detecting the light reflected. from the optical disk 24. That is, the reflected light passes through the objective lens 35, the raising mirror 34, and the beam splitter 33 in this order, and then enters the light-receiving element 30. Then, computation is performed on the signals of the three light spots 25, and a feedback signal is fed to the actuator 36 so as to maintain the current status. Eventually, the objective lens 35 is driven to move. That is, the objective lens 35 changes its position relative to the optical disk 24. Thereby, the light spots 25 are allowed to follow the recording signal arrays of the optical disk 24 rotating at high speed. Hence, by detecting variation in the quantity of the light that entered the light-receiving element 30 after being reflected from the recording surface of the optical disk 24, the information recorded on the optical disk 24 can be read out. In the optical pickup apparatus 20, to ensure that the interval among the three split light spots 25 conforms to the track pitch interval, the semiconductor laser 21 integrally formed with the diffraction grating 31 needs to be adjusted through a rotation about the axis parallel to the x direction, during the assembly of the optical pickup apparatus 20.

Fixedly attached to one thicknesswise end portion of the optical pickup main body 26 is one lengthwise end portion 22a of the first wiring board 22 (hereafter also referred to as the “first flexible printed circuit board 22”) for covering most of the above-mentioned optical components, which is arranged in proximity to the optical components. The first wiring board 22 is formed as a thin platy flexible wiring board, which is composed of films made of a polymeric material such as polyimide having bondedly sandwiched therebetween a copper foil for constituting an electric circuit. The first wiring board 22 has its other end portion 22b arranged in the other thicknesswise end portion of the optical pickup main body 26. A connecter portion 37, which is attached to the other end portion 22b of the first wiring board 22, is connected relatively to a non-illustrated optical disk drive. The first wiring board 22 has its lengthwise substantially middle portion 22c kept curved.

Fixedly attached to part of the surface of the one end portion 22a of the first wiring board 22 is the pressing member 23 formed of a stamped steel sheet made of stainless, for example. The pressing member 23 serves to prevent the first wiring board 22 from being displaced in a direction such as to move away from a plurality of optical components, namely, the optical pickup main body 26. The pressing member 23 is shaped as a thin plate which covers substantially the entire surface of the optical pickup main body 26 (exclusive of the part near the actuator 36), as viewed in the thicknesswise direction, i.e., the z direction. Attached to one edge portion of the pressing member 23 is a pressing pawl 23a extending in the z direction. For example, although not shown in the figure, another pressing pawl is attached to the other adjacent edge portion of the pressing member 23 so as to extend in the z direction. Moreover, for example, those non-illustrated pressing pawls 23a are each kept in engagement with the concavity/convexity formed on the longer side wall portion and/or the shorter side wall portion of the housing 27. By additionally forming the pressing pawl 23a in the pressing member 23, it is possible to uniquely define the relative positions among the optical pickup main body 26, the one end portion 22a of the first wiring board 22, and the pressing member 23 on a virtual plane perpendicular to the z direction. Note that, instead of forming the pressing pawl 23a, it is also possible to form a screw hole at several positions of the housing 27 and the pressing member 23. In this case, the pressing member 23 is fastened to the housing 27 by means of screws.

The first wiring board 22 has opening portions 38 formed only in that area thereof which faces toward portions 21a and 21b of the positionally-adjustable semiconductor laser 21. The portions 21a and 21b each undergo significant displacement at the time of positional adjustment to the semiconductor laser 21. The opening portion 38 is formed in an elliptic shape, as viewed in the z direction. The major axis of the ellipse is aligned with the x direction. Since the opening portions 38 are formed only in that area of the first wiring board 22 which faces toward the portions 21a and 21b of the semiconductor laser 21 that undergo significant displacement at the time of positional adjustment to the semiconductor laser 21, at the time of positionally adjusting the semiconductor laser 21, the portions 21a and 21b subjected to significant displacement pass through the opening portions 38. This helps prevent the semiconductor laser 21 from abutting against the first wiring board 22. Moreover, it is in particular possible to secure a wiring region 39 in the first wiring board 22.

In other words, the wiring region 39 can be secured in that area of the first wiring board 22 which is free of the opening portion 38 facing toward the portions 21a and 21b subjected to significant displacement. Thus, even though the portions 21a and 21b of the semiconductor laser 21 subjected to significant displacement are brought into abutment with the periphery of the opening portion 38, the semiconductor laser 21 can be prevented from being positionally deviated after the positional adjustment. In this way, by forming the opening portions 38 only in that area of the first wiring board 22 which faces toward the portions 21a and 21b subjected to significant displacement, it is possible to easily realize the optical pickup apparatus 20 that can have the wiring region 39 secured in the first wiring board 22 and that can nevertheless be made slimmer as compared with the prior-art construction.

The pressing member 23 has two opening portions 40 formed at the positions thereof facing toward the two opening portions 38 of the first wiring board 22. The opening portion 40 is formed in an elliptic shape, as viewed in the z direction. The major axis of the ellipse is aligned with the y direction. Moreover, the major axis of the ellipse aligned with the y direction is for example approximately two times longer than the major axis of the ellipse defining the opening portion 38 of the first wiring board 22, whereas the minor axis of the ellipse is substantially equivalent in length to the major axis of the ellipse defining the opening portion 38 of the first wiring board 22. By forming the guide piece 23a, it is possible to uniquely define the relative positions among the optical pickup main body 26, the one end portion 22a of the first wiring board 22, and the pressing member 23 on a virtual plane perpendicular to the z direction. Hence, a pair of the opening portions 38 and a pair of the opening portions 40 of the pressing member 23 can be readily arranged so that their centers are positioned at substantially the same coordinates within the virtual plane. In this embodiment, the term “substantially the same coordinate” is to be interpreted as including the same coordinate.

As described thus far, the major axis of the ellipse defining the opening portion 40 is approximately two times longer than the major axis of the ellipse defining the opening portion 38 of the first wiring board 22, whereas the minor axis of the ellipse is substantially equivalent in length to the major axis of the ellipse defining the opening portion 38 of the first wiring board 22. Thus, even though the pressing member 23 is arranged with a slight positional deviation in terms of the y direction with respect to the first wiring board 22, the amount of the positional deviation can be accommodated by the major axis of the ellipse. Thus, the opening portion 40 of the pressing member 23 is made larger at least than the opening portion 38 of the first wiring board 22 and is arranged so that their centers are positioned at substantially the same coordinates. At the time of positional adjustment to the semiconductor laser 21, the portions 21a and 21b subjected to significant displacement pass through the opening portions 38 and 40. This helps prevent the semiconductor laser 21 from abutting against the first wiring board 22 and the pressing member 23.

According to the optical pickup apparatus 20 thus far described, the first wiring board 22 has the opening portions 38 formed only in that area thereof which faces toward the portions 21a and 21b of the semiconductor laser 21 that undergo significant displacement at the time of positional adjustment to the semiconductor laser 21. The opening portion 40 of the pressing member 23 and the opening portion 38 are arranged in substantially the same coordinates, and the opening portion 40 is made larger than the opening portion 38. Thus, when the semiconductor laser 21 is positionally adjusted through a rotation about the axis parallel to the x direction, at least the portions 21a and 21b subjected to significant displacement pass through the opening portion 38 of the first wiring board 22 and the opening portion 40 of the pressing member 23. Thereupon, the semiconductor laser 21 and the first wiring board 22 are no longer brought into abutment with each other. Thus, as shown in FIG. 3, the first wiring board 22 and the pressing member 23 can be arranged in proximity to the optical pickup main body 26 in the z direction.

Even though the portions 21a and 21b of the semiconductor laser 21 subjected to significant displacement are brought into abutment with the periphery of the opening portion 38 of the first wiring board 22, since the first wiring board 22 possesses flexibility, the periphery of the opening portion 38 of the first wiring board 22 is elastically deformed at that time. Therefore, the force transmitted from the semiconductor laser 21 to the first wiring board 22 can be dispersed. Then, since the opening portion 40 of the pressing member 23 and the opening portion 38 are arranged in substantially the same coordinates and the opening portion 40 is made larger than the opening portion 38, it never occurs that the portions 21a and 21b of the semiconductor laser 21 subjected to significant displacement are brought into abutment with the metal-made pressing member 23 which is greater in rigidity than the first wiring board 22. Hence, the semiconductor laser 21 can be prevented from being positionally deviated after the positional adjustment. Moreover, the wiring region 39 can be secured in that area of the first wiring board 22 which is free of the opening portion 38 facing toward the portions 21a and 21b subjected to significant displacement. In this way, by forming the opening portions 38 only in that area of the first wiring board 22 which faces toward the portions 21a and 21b subjected to significant displacement, it is possible to easily realize the optical pickup apparatus 20 that can have the wiring region 39 secured in the first wiring board 22 and that can nevertheless be made slimmer.

The size of the opening portion 38 is determined in consideration of the size of the wiring region 39 required in the area between the two opening portions 38 and its periphery. Specifically, in the case of obtaining as large the wiring region 39 as possible, the size of the opening portion 38 is set at a minimum value within the limits of allowing for the maximum displacement point at which the portions 21a and 21b undergo maximum displacement. By contrast, in the case of making the wiring region 39 relatively narrow, the opening portion 38 can be made larger in area. Thereby, the first wiring board 22 and the pressing member 23 can be arranged closer to the optical pickup main body 26 in the z direction, whereby making it possible to achieve further slenderization of the optical pickup apparatus 20.

The pressing member 23 is provided to prevent the first wiring board 22 from being displaced in a direction such as to move away from the optical pickup main body 26. Thus, the first wiring board 22 can be prevented from being inconveniently displaced in a direction such as to move away from a plurality of optical components without fail by the pressing member 23. In other words, the first wiring board 22 can be prevented without fail from upwardly moving out of the optical pickup main body 26. Since the first wiring board 22 is a flexible wiring board, by exploiting its flexibility, the layout and displacement of the first wiring board 22 can be achieved with ease. By employing the first wiring board 22 having flexibility, the optical pickup apparatus 20 can be driven with moveability.

The semiconductor laser 21 has the diffraction grating 31 integrally formed therewith for making working light beams converge at a plurality of positions on the optical disk 24. Thus, by positionally adjusting the semiconductor laser 21, the diffraction grating 31 integrally formed with the semiconductor laser 21 is also positionally adjusted. Performing the positional adjustment on the diffraction grating 31 makes it possible to adjust the pitch among a plurality of positions of the working light beams converging on the optical disk 24.

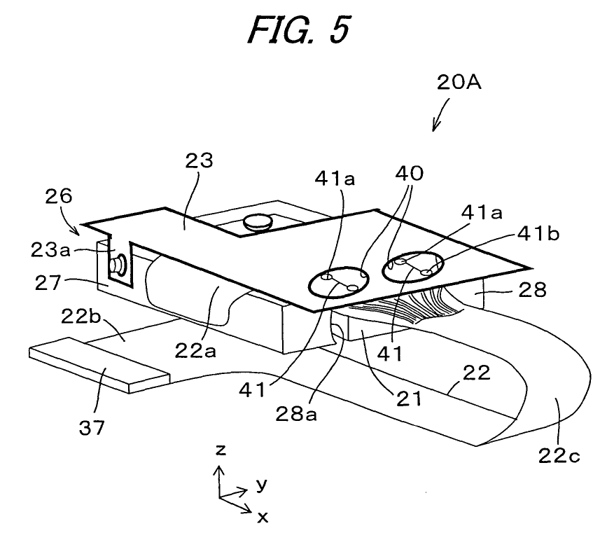

FIG. 5 is a perspective view of a modified embodiment obtained by partly modifying the embodiment of the invention, illustrating an optical pickup apparatus 20A in which the opening portion of the first wiring board 22 is slit-shaped. Note that the components that play the same or corresponding roles as in the above-described embodiments will be identified with the same reference symbols, and detailed descriptions will be omitted. The first wiring board 22 has slit-shaped opening portions 41 formed only in that area thereof which faces toward the portions 21a and 21b (refer to FIG. 3) of the semiconductor laser 21 that undergo significant displacement at the time of positional adjustment to the semiconductor laser 21. The opening portions 41 are each formed as a slit extending in a direction parallel to the x direction. The slit is substantially equivalent in dimension to the minor axis of the ellipse defining the opening portion 40 of the pressing member 23. In this embodiment, the term “substantially the same dimension” is to be interpreted as including the same dimension.

Each of x direction-wise ends 41a and 41b of the opening portion 41 is formed in the shape of a circular hole, as viewed in the z direction. Hence, even though the portions 21a and 21b of the semiconductor laser 21 subjected to significant displacement are brought into abutment with the periphery of the opening portion 41, it is possible to alleviate the stress concentration exerted on the x direction-wise ends 41a and 41b. Since the stress concentration exerted on the x direction-wise ends 41a and 41b of the opening portion 41 can be alleviated, the wiring board 22 can be protected against undesirable rupture.

According to the modified embodiment, the first wiring board 22 has the slit-shaped opening portions 41 formed only in that area thereof which faces toward the portions 21a and 21b of the semiconductor laser 21 that undergo significant displacement at the time of positional adjustment to the semiconductor laser 21. The slit-shaped opening portion 41 extends along the x direction. This makes it possible in particular to secure, in the first wiring board 22, a wiring region 39A which is far larger in area than the wiring region 39 of the embodiment described previously. Otherwise, this modified embodiment offers the same effects as achieved in the previously-described embodiment.

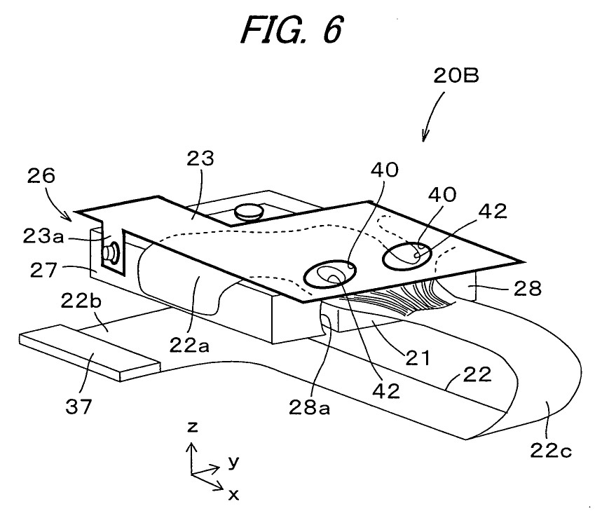

FIG. 6 is a perspective view of a modified embodiment obtained by partly modifying the embodiment of the invention, illustrating an optical pickup apparatus 20B in which the opening portion of the first wiring board 22 is notch-shaped. Note that the components that play the same or corresponding roles as in the above-described embodiments will be identified with the same reference symbols, and detailed descriptions will be omitted. The first wiring board 22 has notch-shaped opening portions 42 formed only in that area thereof which faces toward the portions 21a and 21b of the semiconductor laser 21 that undergo significant displacement at the time of positional adjustment to the semiconductor laser 21. The opening portions 42 are each formed as a notch extending from the position corresponding to the opening portion 40 of the pressing member 23 to an outer edge 22d of the first wiring board 22.

As described heretofore, according to the modified embodiment, particularly, the opening portion 42 of the first wiring board 22 is formed as a notch extending over the outer edge 22d of the first wiring board 22. Hence, even though the portion of the optical component subjected to significant displacement is brought into abutment with the periphery of the opening portion 42, since the first wiring board 22 possesses flexibility, deformation appears moderately over the wide area including the outer edge of the first wiring board 22. As a result, the force transmitted from the optical component to the first wiring board 22 can be dispersed over a wider area than in the case of giving the opening portion a shape other than a notch. Hence, the optical component can be prevented from being positionally deviated after the positional adjustment. Otherwise, this modified embodiment offers the same effects as achieved in the optical pickup apparatus 20.

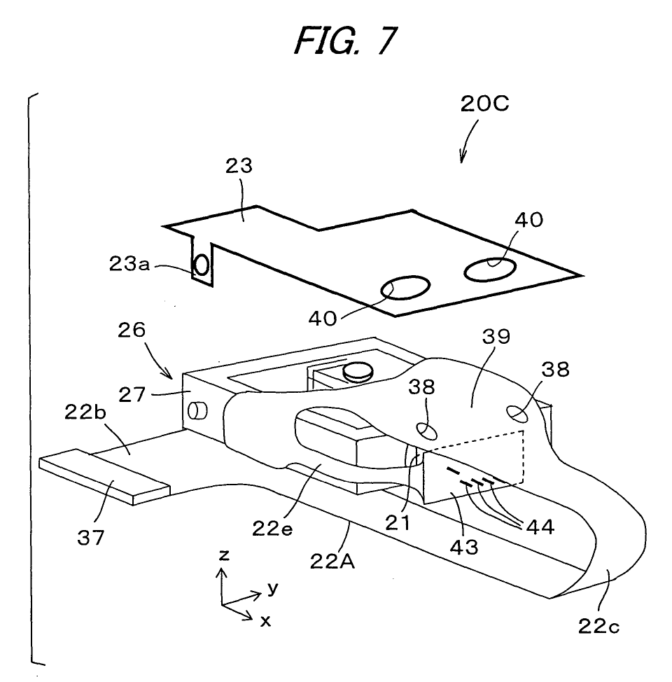

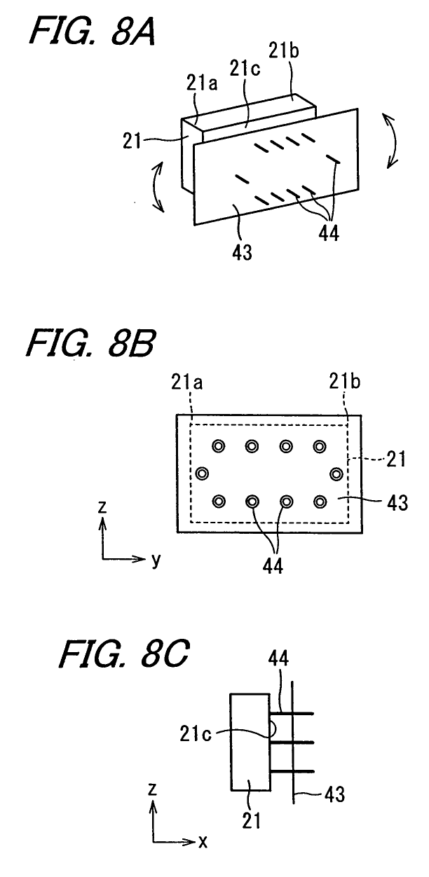

FIG. 7 is an exploded perspective view of another embodiment of the invention, illustrating an optical pickup apparatus 20C provided additionally with a second wiring board 43 which is electrically connected to a first wiring board 22A, is made rotatable, and has optical components mounted thereon. FIGS. 8A through 8C are partly enlarged views of the second wiring board 43 and the semiconductor laser 21, with FIG. 8A showing a perspective view of the second wiring board 43 and the semiconductor laser 21, FIG. 8B showing a front view of the second wiring board 43 as seen from one side in the x direction, and FIG. 8C showing a sectional view of the second wiring board 43 and the semiconductor laser 21 sectioned along a virtual plane which is perpendicular to the y direction. Note that the components that play the same or corresponding roles as in the above-described embodiments will be identified with the same reference symbols, and detailed descriptions will be omitted.

The optical pickup apparatus 20C is mainly composed of the optical pickup main body 26; the first wiring board 22A which is electrically connected to the optical pickup main body 26; the second wiring board 43; and the pressing member 23. The second wiring board 43 is electrically connected, via a connecting portion 22e, to the first wiring board 22A. The second wiring board 43 is formed in a rectangular shape, as viewed in the x direction. The second wiring board 43 is so arranged as to face toward one surface portion 21c of the semiconductor laser 21, or equivalently the optical component, with a predetermined interval secured therebetween.

In the second wiring board 43, a plurality of connecting terminals 44 are piercingly formed so as to extend in the x direction. The semiconductor laser 21 is mounted at one x direction-wise end portions of the connecting terminals 44. The second wiring board 43, which is electrically connected to the first wiring board 22A, is so designed as to be rotatable about the axis parallel to the x direction. Thus, the semiconductor laser 21 mounted in the second wiring board 43 is positionally adjusted by the rotation of the second wiring board 43. Otherwise, this embodiment offers the same effects as achieved in the embodiments described hereinbefore.

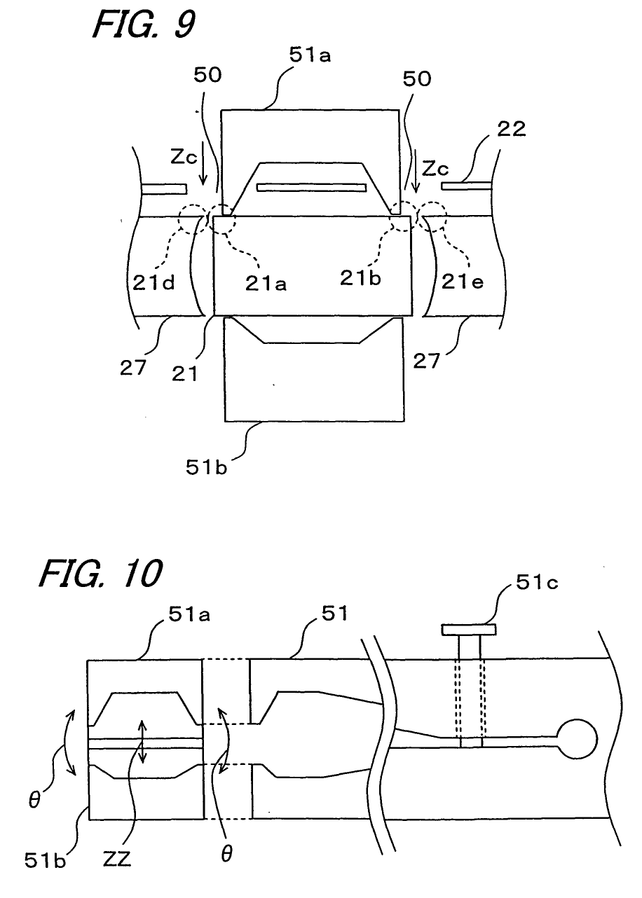

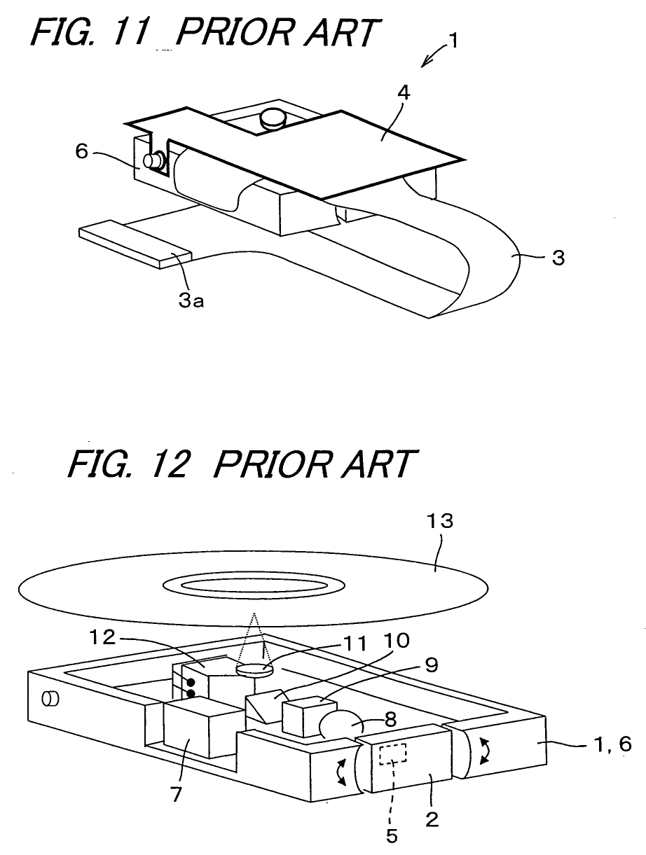

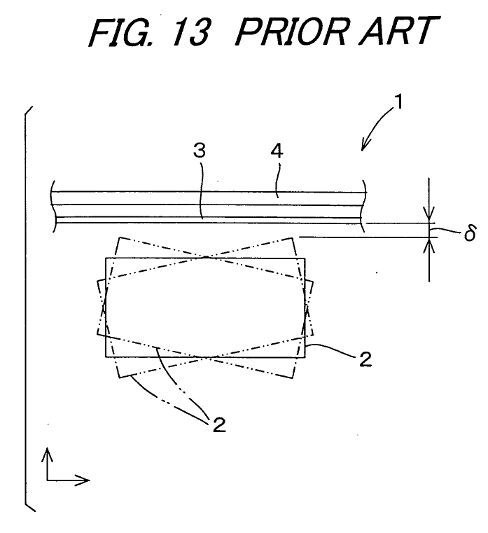

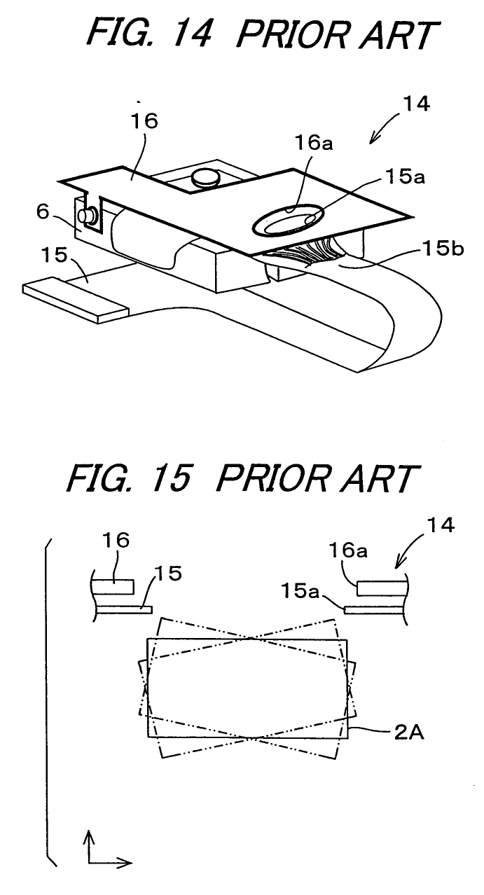

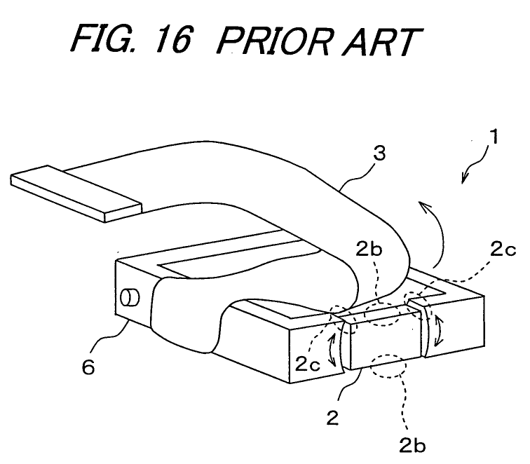

FIG. 9 is a sectional view of a fourth embodiment obtained by partly modifying the embodiment of the invention. In this embodiment, the flexible printed circuit board 22 has opening portions 50. Here, the opening portion 50, 50 is formed so as not only to face toward the portion 21a, 21b of the positionally-adjustable semiconductor laser 21 subjected to significant displacement at the time of positional adjustment, but also to face toward the portion 21d, 21e which is adjacent to the housing 27.

Part of the contour of the semiconductor laser 21 is exposed through the opening portion 50 of the flexible printed circuit board 22. Hence, during the rotational adjustment, the semiconductor laser 22 can be held, moved, and bondedly fixed without making contact with the flexible printed circuit board 22.

FIG. 10 is a view of an adjustment tool 51 for use in rotational adjustment, illustrating its front and side. The adjustment tool 51 is shaped like two long metal-made plates conjoined to each other at their bottoms. At each of its end portions 51a and 51b are attached two pieces of pawl-shaped projections for holding the semiconductor laser. The projection of the end portion 51a is made hollow at its inside more deeply than in the end portion 51b, to release the flexible printed circuit board 22. By rotating an adjustment screw 51c, the end portion 51a is moved in ZZ direction with respect to the end portion 51b, so that the interval between the end portions is varied freely. Moreover, by moving a non-illustrated gonio-stage attached to the adjustment tool 51, the end portions 51a and 51b can be rotated in θ direction.

The rotational adjustment is conducted as follows. At first, the end portion 51b of the adjustment tool is inserted to bring the projection into contact with the semiconductor laser 21. Then, the adjustment screw 51c is rotated to bring the end portion Sa closer and into contact with part of the semiconductor laser 21 exposed through the opening portion 50. After holding and rotating the semiconductor laser 21 until it is placed in the predetermined position, the adjustment tool 51 is left intact. Subsequently, using a dispenser, ultraviolet curing resin is applied, through the opening portion 50, to the gap between the semiconductor laser 21 and the housing 27. Further, ultraviolet rays are irradiated through the opening portion 50 in Zc direction to cure the resin applied. Upon completion of the resin hardening, the adjustment tool 51 is removed. Thereupon, the semiconductor laser 21 is secured with the desired rotation angle maintained.

As described heretofore, according to this modified embodiment, the semiconductor laser 21 can be rotationally adjusted and thereafter secured without moving the flexible printed circuit board 22 covering the semiconductor laser 21. All of the necessary operations can be readily conducted, through the opening portion 50 of the flexible printed circuit board, while the progress of the operations being visually checked from above in the thicknesswise direction.

As another example of the embodiment of the invention, it is also possible to make the opening portion 40 of the pressing member 23 identical in size with the opening portion 38 of the first wiring board 22, and arrange these opening portions 38 and 40 so that their centers are positioned at the same coordinates within a virtual plane perpendicular to the z direction. Note that the opening portion of the pressing member 23 and the opening portion of the first wiring board 22 do not necessarily have to have the same size.

In the above-described embodiments, since one z direction-wise side of the semiconductor laser is fully covered with the first wiring board and the pressing member, the first wiring board and the pressing member each have a pair of opening portions corresponding to the portions of the semiconductor laser subjected to significant displacement. In the alternative, the first wiring board and the pressing member can also be designed so as to cover only one-side portion of the semiconductor laser in terms of the y direction. In this case, the first wiring board and the pressing member no longer require a pair of opening portions but require only one opening portion. Hence, not only it is possible to reduce the manufacturing cost of the first wiring board because of the needlessness of the extra opening formation, but it is also possible to further increase the wiring region of the first wiring board.

The invention is also applicable to the case of conducting positional adjustment, during the assembly of the optical pickup apparatus, by rotating an optical component other than the semiconductor laser. One example is that a semiconductor laser is mounted in a holder, and the holder carrying the semiconductor laser is made rotationally adjustable. Another example is that a hologram laser is constructed by combining together a semiconductor laser and a light-receiving element, and the hologram laser is made rotatable. Still another example is that a light-receiving element is made rotatable. In either case, when positional adjustment is conducted by rotating such an optical component, the same effects as achieved in the above- described embodiments can be attained so long as an opening portion, which is substantially the same as in the above- described embodiments, is formed in the first wiring board and the pressing member for covering the optical component to be rotationally adjusted. Obviously, many modifications and variations of the above-described embodiments are possible within the scope of the appended claims.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An optical pickup apparatus comprising:
a plurality of optical components including a light-emitting element which emits working light for recording or reproducing information with respect to a recording medium;
a housing for mounting therein the optical components; and
a first wiring board which is electrically connected to the light-emitting element,
wherein at least one of the optical components is made positionally adjustable,
and wherein the first wiring board has an opening portion formed in an area thereof which is located in proximity to the positionally-adjustable optical component.

2. The optical pickup apparatus of claim 1,
wherein, in the first wiring board, the opening portion is formed in an area facing toward part of the positionally-adjustable optical component that undergoes significant displacement at the time of positional adjustment to the optical component.

3. The optical pickup apparatus of claim 1,
wherein a gap is created between the positionally-adjustable optical component and the housing arranged adjacent to the optical component,
and wherein the first wiring board has an opening portion formed in an area thereof which faces toward the gap.

4. The optical pickup apparatus of claim 1, further comprising:
a pressing member for preventing the first wiring board from being displaced in a direction such as to move away from the optical component.

5. The optical pickup apparatus of claim 1,
wherein the first wiring board is formed as a flexible wiring board.

6. The optical pickup apparatus of claim 1,
wherein the positionally-adjustable optical component includes a light-emitting element which has a diffraction grating integrally formed therewith for making working light beams converge at a plurality of positions on a recording medium.

7. The optical pickup apparatus of claim 6, further comprising:
a rotatable holder for accommodating the optical component,
wherein the optical component can be positionally adjusted by the rotation of the holder.

8. The optical pickup apparatus of claim 6, further comprising:
a second wiring board that is electrically connected to the first wiring board, is made rotatable, and has the optical component mounted thereon,
and wherein the optical component can be positionally adjusted by the rotation of the second wiring board.

9. The optical pickup apparatus of claim 1,
wherein the positionally-adjustable optical component includes a light-receiving element.

10. The optical pickup apparatus of claim 1,
wherein the positionally-adjustable optical component is a light emitting/receiving element constituted by combining together a light-emitting element and a light-receiving element.

11. The optical pickup apparatus of claim 5,
wherein the opening portion of the flexible wiring board is slit-shaped.

12. The optical pickup apparatus of claim 1,
wherein the opening portion is formed as a notch extending over the outer edge of the first wiring board.

13. A method for adjusting an optical pickup apparatus composed of a plurality of optical components including a light-emitting element which emits working light for recording or reproducing information with respect to a recording medium; a housing for mounting therein the optical components; and a first wiring board which is electrically connected to the light-emitting element, comprising the steps of:
making at least one of the optical components positionally adjustable;
forming an opening portion in an area of the first wiring board which faces toward part of the optical component that undergoes significant displacement at the time of positional adjustment; and
adjusting the position of the positionally-adjustable optical component by means of an adjustment tool inserted externally through the opening portion.

14. A method for adjusting an optical pickup apparatus composed of a plurality of optical components including a light-emitting element which emits working light for recording or reproducing information with respect to a recording medium; a housing for mounting therein the optical components; and a first wiring board which is electrically connected to the light-emitting element, comprising the steps of:
making at least one of the optical components positionally adjustable;
forming an opening portion in an area of the first wiring board which faces toward a gap created between the positionally-adjustable optical component and the housing arranged adjacent to the optical component; and
bonding the positionally-adjustable optical component to the housing by applying an adhesive through the opening portion.

15. A method for adjusting an optical pickup apparatus composed of a plurality of optical components including a light-emitting element which emits working light for recording or reproducing information with respect to a recording medium; a housing for mounting therein the optical components; and a first wiring board which is electrically connected to the light-emitting element, comprising the steps of:
making at least one of the optical components positionally adjustable;
forming an opening portion in an area of the first wiring board which faces toward a gap created between the positionally-adjustable optical component and the housing arranged adjacent to the optical component;
adjusting the position of the positionally-adjustable optical component by means of an adjustment tool inserted externally through the opening portion; and
bonding the positionally-adjustable optical component to the housing by applying an adhesive through the opening portion.
